(19) United States
(12) Patent Application Publication
(10) Pub. No.: US 2019/0129413 A1
(43) Pub. Date: May 2, 2019

(54) FLEXIBLE REMOTE VEHICLE CONTROL

(71) Applicant: GM GLOBAL TECHNOLOGY OPERATIONS LLC, Detroit, MI (US)

(72) Inventors: Spencer W. Chamberlain, Sterling Heights, MI (US); Chester R. Wisniewski, Royal Oak, MI (US); Jennifer A. Cooper-Sturgess, Lake Orion, MI (US); John McDougall, Detroit, MI (US); Dave W. Heyne, Royal Oak, MI (US)

(21) Appl. No.: 15/794,498

(22) Filed: Oct. 26, 2017

(51) Int. Cl. G05D 1/00; G05D 1/02; G07C 5/00

(52) U.S. Cl. CPC G05D 1/0022; G05D 1/0088; G07C 5/008; G05D 1/0016; G05D 1/021

(57) ABSTRACT

A method for controlling an autonomous vehicle includes the use a software application to order the use of the autonomous vehicle. Thereafter, the software application can be used to determine an amount of control over the autonomous vehicle held by one or more passengers of the trip. The software can be used remotely from the autonomous vehicle, as opposed to being used by the one or more passengers.

### INTRODUCTION

The subject disclosure relates to a method and system for implementing improved control of an autonomous automobile service from a remote location.

A typical automotive vehicle is under the control of a human being. Typically, the human being using a vehicle owns, leases, rents, or has another interest in the automotive vehicle. The human being driving the automotive vehicle is in control of all aspects of the automotive vehicle.

A few innovations are changing the use of automotive vehicles—ride sharing and autonomous vehicles. A ride sharing service is similar to a taxi in that a passenger hires a vehicle to take the passenger to a certain location. Autonomous vehicles have varying levels of computerized control of the automotive vehicle. In combination, a ride-sharing service that utilizes autonomous vehicles would involve a passenger hiring a vehicle for temporary use, where the vehicle is controlled by a computer rather than by a human being.

One aspect of an autonomous, ride-sharing vehicle that has not been addressed is who is in control of the autonomous, ride-sharing vehicle. When a competent adult is in such a vehicle, the adult is typically in charge of the vehicle and can direct or make changes to the autonomous vehicle. But in certain situations, the passenger of such a vehicle may be a minor or may have diminished capacity. It would be desirable to have a method and system of controlling such a vehicle from a remote location.

### SUMMARY

In one exemplary embodiment, a method for controlling an autonomous vehicle includes the use a software application to order the use of the autonomous vehicle. Thereafter, the software application can be used to determine an amount of control over the autonomous vehicle held by one or more passengers of the trip. The software can be used remotely, away from the autonomous vehicle, as opposed to being used by the one or more passengers.

In addition to one or more of the features described herein, further embodiments may include wherein determining an amount of control over the autonomous vehicle includes providing remote approval for the boarding of passengers on the vehicle.

In addition to one or more of the features described herein, further embodiments may include wherein providing remote approval for the boarding of passengers on the vehicle includes viewing a video image from a proximity of the vehicle and providing an approval of the boarding of passengers using the software application.

In addition to one or more of the features described herein, further embodiments may include wherein providing remote approval for the boarding of passengers on the vehicle includes allowing the one or more passengers to provide approval for the boarding of passengers.

In addition to one or more of the features described herein, further embodiments may include wherein determining an amount of control over the autonomous vehicle includes controlling an availability of services provided by the vehicle.

In addition to one or more of the features described herein, further embodiments may include wherein the services include provision of food or beverages to the one or more passengers.

In addition to one or more of the features described herein, further embodiments may include wherein determining an amount of control over the autonomous vehicle includes controlling an availability to one or more passengers of the vehicle of one or more of seat controls, window controls, audio/visual controls, heating controls, and air conditioning controls.

In addition to one or more of the features described herein, further embodiments may include wherein determining an amount of control over the autonomous vehicle includes controlling an availability of destination control provided to one or more passengers of the vehicle.

In addition to one or more of the features described herein, further embodiments may include wherein determining an amount of control over the autonomous vehicle comprises using a graphical user interface to input a level of control to provide to the one or more passengers of the vehicle.

In one exemplary embodiment, a method for controlling an autonomous vehicle comprises receiving an order for the autonomous vehicle to make a trip. Thereafter dispatching the autonomous vehicle to a requested location. Embodiments may include receiving instructions regarding an amount of control over the autonomous vehicle held by one or more passengers of the trip, wherein the instructions are received remotely from the autonomous vehicle.

In addition to one or more of the features described herein, further embodiments may include wherein the instructions regarding the amount of control over the autonomous vehicle include remote approval of the boarding of passengers on the vehicle.

In addition to one or more of the features described herein, further embodiments may include wherein the remote approval for the boarding of passengers on the vehicle comprises providing a video image from a proximity of the vehicle to the remote device. Embodiments may further include receiving an approval of the boarding of passengers from the remote device.

In addition to one or more of the features described herein, further embodiments may include wherein receiving approval for the boarding of passengers on the vehicle includes receiving instructions to allow the one or more passengers to provide approval for the boarding of passengers.

In addition to one or more of the features described herein, further embodiments may include wherein receiving instructions regarding the amount of control over the autonomous vehicle includes controlling an availability of services provided by the vehicle.

In addition to one or more of the features described herein, further embodiments may include wherein the services include provision of food or beverages to the one or more passengers.

In addition to one or more of the features described herein, further embodiments may include wherein receiving instructions regarding the amount of control over the autonomous vehicle includes controlling an availability to one or more passengers of the vehicle of one or more of the following: seat controls, window controls, audio/visual controls, heating controls, and air conditioning controls.

In addition to one or more of the features described herein, further embodiments may include wherein receiving instructions regarding the amount of control over the autonomous vehicle includes controlling an availability of destination control provided to one or more passengers of the vehicle.

In addition to one or more of the features described herein, further embodiments may include wherein determining an amount of control over the autonomous vehicle comprises using a graphical user interface to input a level of control to provide to the one or more passengers of the vehicle

The above features and advantages and other features and advantages are readily apparent from the following detailed description when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a block diagram presenting an overview of one or more embodiments;

FIG. 2 is a screen shot of an application of one or more embodiments;

FIG. 3 is a screen shot of an application of one or more embodiments;

FIG. 4 is a flow chart illustrating the operation of one or more embodiments;

FIG. 5 is a block diagram of a computer system that can be used to implement one or more embodiments; and

FIG. 6 is a block diagram of a computer program product that can be used to implement one or more embodiments.

### DETAILED DESCRIPTION

The following description is merely exemplary in nature and is not intended to limit the present disclosure, its application or uses.

In accordance with an exemplary embodiment, one or more embodiments are shown of a flexible system and method for remotely controlling an autonomous vehicle.

As automotive vehicles become more autonomous, there is less need for physical input from a person to the vehicle. A commonly used scale illustrating levels of autonomous driving includes levels numbered 0 through 5. Level 0 is a vehicle has no driving automation. Level 1 is a vehicle that has assistance to the driver. Level 2 is a vehicle that has partial driving automation. Level 3 is a vehicle that has conditional driving automation. Level 4 is a vehicle that has high driving automation. And level 5 is a vehicle that has full driving automation. In general, the higher the level number, the less input is required from a human.

Traditional automotive vehicles utilize physical inputs to direct the operation of the automotive vehicle. These inputs include inputs used to drive the vehicle, such as the steering wheel and the pedals. These inputs also include other systems of the vehicle, such as climate control, audio/visual systems, window position, seat position, mirror position, turn signals, transmission controls, and the like. Because the automotive vehicle is under the control of a human, it has become standard to also utilize physical human inputs to control the various systems of the vehicle. This can include dials, levers, knobs, buttons, and the like that are used to operate the systems.

In an automotive vehicle with a high level of automation, the identity of the person in control of the automation can be of importance. While, in general, the person in control of the automotive vehicle is also a passenger of the vehicle, that situation may not always be true. In both situations that involve the use of ride sharing services and situations involving the use of personal vehicles, there can be situations where it is desirable to have a person who is not a passenger of the automotive vehicle be in control of the automotive vehicle. In such situations, there can be a desire to allow a person who is remote from the automotive vehicle to have certain levels of control of the autonomous vehicle.

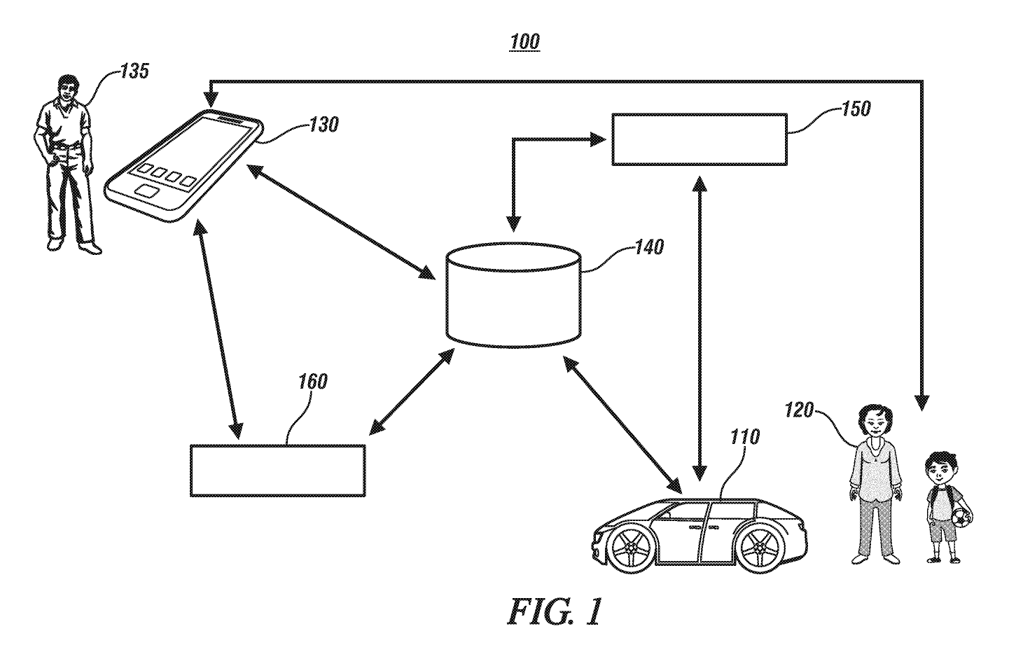

With reference to FIG. 1, a block diagram illustrating an overview of one or more embodiments is shown. System 100 includes a variety of different components. In an exemplary situation, an automotive vehicle 110 is to be used by passenger(s) 120. In some situations, it is not desirable to allow passenger(s) 120 to have control of the automotive vehicle 110. For example, the passenger may be a minor or the passenger may be suffering from a disability that makes it difficult for passenger(s) 120 to make a decision. Although, automotive vehicle 110 has a high level of autonomous features, and is capable of driving from an origin to a destination without human input, there can be changes that are allowed or disallowed for a certain trip. And there should be a way to input the initial destination.

In one or more embodiments, a primary service controller 135 is able to use a software application (also known as an “app” or a “program”) executing on remote device 130 to control certain aspects of a trip. For example, remote device 130 can be used to input the destination of the trip. Aspects of the trip, such as the route to used, driving modes to be used, and the like can be set via the remote device 130. In some embodiments, remote device 130 can be an electronic device with Internet connectivity, such as a mobile phone, a tablet, a laptop, an e-reader, a personal digital assistant (PDA), a desktop computer, or any other type of electronic device that has Internet connectivity.

Remote device 130 is in electronic communication with back office server 140. Back office server 140 can provide a variety of different functions. In a ride-sharing embodiment, back office server 140 can dispatch the automotive vehicle to the location of passenger(s) 120. Back office server is in communication with automotive vehicle 110 and can provide a variety of data, such as the intended destination, and any restrictions for the trip (e.g., roads to avoid, top speed allowed, and the like.) Local data 150 provides additional information to back office 140 and automotive vehicle 110. The local data can include aspects that are particular to a location, such as the timing and amount of toll roads, the hours of operation of certain locations, traffic, and the like.

Services 160 are additional, non-driving related services provided to automotive vehicle 110, possibly for use by passenger(s) 120. For example, an automotive vehicle can have food and beverages available for consumption by passenger(s) 120. Other services can include entertainment, such as music, audio books, Internet connectivity, video games, movies, TV shows, and other forms of video entertainment. In some embodiments, services 160 are located within automotive vehicle 110.

Connections between the various components illustrated in FIG. 1 can be via the Internet. Connection of each component to the Internet and other external computing systems can be accomplished through the use of any wired or wireless methods or combination thereof. Wired methods can include powerline connections, Ethernet, fiber optics, and the like. Wireless methods can include a transceiver coupled to an antenna, wherein the transceiver sends and receives signals using one of a variety of different protocols, such as cellular data protocols (e.g., 4G, LTE, UTMS, WiMAX, and the like) or via WiFi. In addition, satellite navigation signals (e.g., GPS or GLONASS) can be received by one or more of the components to provide location information. For example, automotive vehicle 110 can receive satellite navigation signals that can be interpreted to determine the location of automotive vehicle 110. The location of automotive vehicle 110 can be sent to back office 140 such that back office 140 can track the location of automotive vehicle. In addition, location information can be sent to remote device 130 such that primary service controller 135 is able to track the location of automotive vehicle 110.

In one or more embodiments, primary service controller 135 can change the amount of control that passenger(s) 120 have over vehicle 110. Even in an autonomous vehicle, it can be desirable to have passenger(s) 120 in control over certain aspects of the vehicle. There are interior comfort aspects, such as air conditioning, heating, and windows, seat position, and the like. There are interior entertainment aspects, such as the choice of audio and/or visual entertainment. There is also routing information. For example, medical emergencies can occur, where a re-routing to an emergency medical facility can be requested. Less important situations can occur, such as passenger(s) 120 needing to use a bathroom, or passenger(s) 120 may have forgotten something and wants to return to the pick-up location. Passenger(s) 120 can pass by a grocery store and remember that he needed to pick up some groceries. In situations where the passenger(s) 120 is in control of the vehicle the passenger can provide such input to vehicle 110, which will then respond accordingly. However, in some circumstances, it may not be desirable to give passenger(s) 120 that kind of authority. There are other areas of control of the vehicle, such as the ability to control the speed of the vehicle, a driving mode of the vehicle (ranging from fuel efficient to sporty), and route options (e.g., avoiding highways or avoiding toll roads) that can be under at least partial control of the passenger(s).

For example, the passenger may be a child. In such a situation, it might not be desirable to allow a child to change the destination of vehicle 110. Passenger 120 may be a person who is not mentally capable of controlling vehicle 110 or it is not desirable to have the person controlling vehicle 110. In other circumstances, an intermediate level of control might be desirable. For example, passenger(s) 120 might include both a child and an accompanying a babysitter. In such a case, it might be desirable to allow the babysitter to have some control over vehicle 110 (such as the ability to respond to emergencies or to change the comfort level of the vehicle), but not have the ability to change other aspects of the vehicle (such as the ability to change the destination in the absence of an emergency). In some circumstances, it can be desirable to allow more freedom over some aspects of vehicle 110, but less freedom over other aspects of vehicle 110. Aspects where the amount of passenger control can be set include one or more of the following: seat controls, window controls, audio/visual controls, heating controls, and air conditioning controls.

For example, it can be desirable to allow the passenger(s) 120 to have some freedom over the interior environment of the automotive vehicle, but to not allow non-authorized users to enter the vehicle. For example, a parent can allow their child to allow their authorized friends to be in vehicle 110, but not people who are not authorized.

The control can also include control over services 160. As stated above, services 160 can include access to food and/or beverages. In a ride-sharing embodiment, the access to food can be a provided for an additional fee. Because of the additional fee, there can be circumstances where it is not desirable to allow passenger(s) 120 to incur the additional fee. Even in non-ride-sharing embodiments, it can be desirable to restrict passenger(s) 120 from having access to all capabilities of vehicle 110. For example, restrictions can be made to Internet access, volume of an audio system, videos viewable by passenger(s) 120, the ability to open windows or sunroofs, and the like.

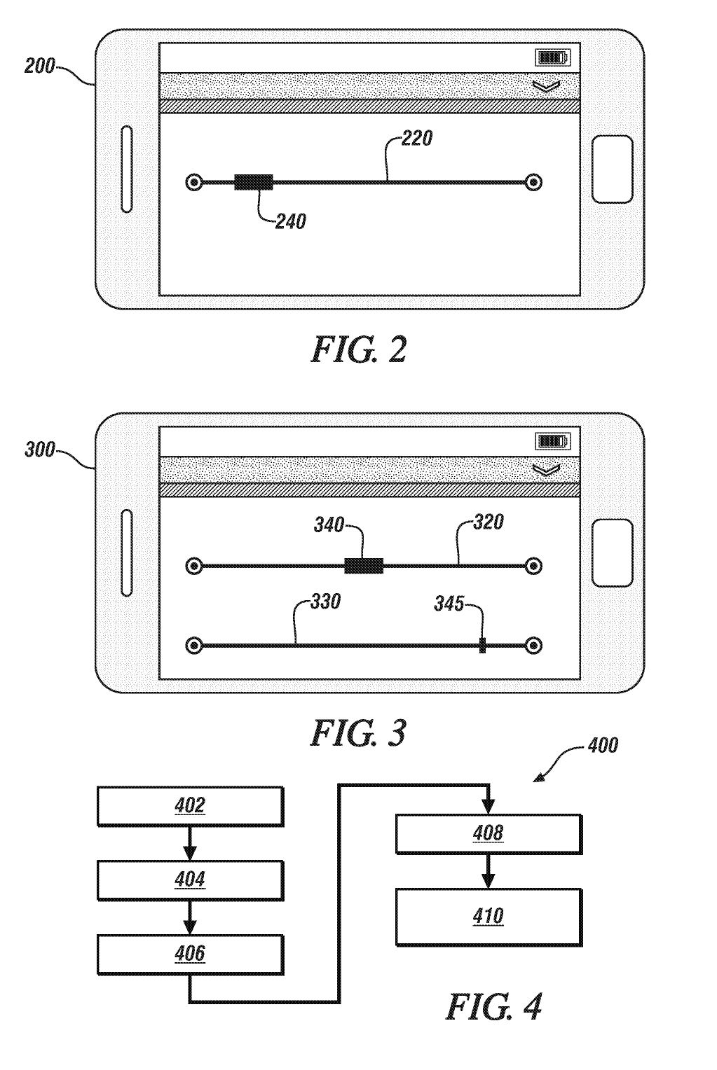

With reference to FIG. 2, an exemplary screen shot is shown that illustrates exemplary levels of control available to primary service controller 135. FIG. 2 shows a screen of an exemplary remote device 200 (which can be the same as remote device 130 of FIG. 1). The contents of the screen include a slider 220. A movable portion 240 of the slider can be moved by primary service controller 135. In some embodiments, the sliding scale can be numbered (e.g., from 1 to 5 or however many levels of control are available to primary service controller 135.) In some embodiments, the sliding scale can have names for the various levels of control (e.g., ranging from “close care” to “freedom”). In the exemplary situation of FIG. 2, the sliding scale can be at or near the “close care” side such that the passenger(s) 120 can have little to no control of the vehicle, with only primary service controller 135 having those abilities. It should be understood that the application can have other screens that would allow primary service controller 135 to monitor the trip, make changes to the trip, and the like, as will be explained in greater detail herein.

In FIG. 3, an exemplary screen shot is shown that illustrates additional exemplary levels of control available to primary service controller 135. While primary service controller 135 would typically want to control who is allowed in the vehicle, primary service controller 135 might also want to allow some flexibility. FIG. 3 shows a screen of an exemplary remote device 300 (which can be the same as remote device 130 of FIG. 1). The screen includes slider 320. A movable portion 340 of the slider can be moved by primary service controller 135. In some embodiments, the sliding scale can be numbered (e.g., from 1 to 5 or however many levels of control are available to primary service controller 135.) In some embodiments, the sliding scale can have names for the various levels of control (e.g., ranging from “close care” to “freedom”). The screen also includes slider 330 with a movable portion 345. Slider 330 controls who is allowed in the vehicle through the use of movable portion 345. Slider 330 can have various levels of presets that can be numbered or named. For example, the scale can have “anonymous” at one end, which allows any person to enter the vehicle. The other end of the scale can be “lockdown,” which does not allow any person to enter except the intended passenger.

There can be circumstances when an intermediate level of control can be desired. For example, primary service controller 135 may want to allow passenger 120 to have some guests, but not others. Or passenger 120 may have a limit to the number of guests.

One exemplary situation can include a teenage passenger 120 and a friend. The passengers can be minors while primary service controller 135 is a parent or guardian. Primary service controller 135 can allow the minor passenger 120 to have her previously authorized friend to enter the car. Thus, movable portion 345 on slider 330 might not be all the way to the “lockdown” side of the scale, such that the previously authorized friend can enter the vehicle. But if movable portion 345 on slider 330 is not all the way to the “anonymous” side of the scale, primary service controller 135 has some control over who is allowed in the car, such as only allowing previously authorized people in the vehicle.

The control over who is allowed in the vehicle can occur in a variety of different manners. In some embodiments, there are one or more cameras located in the vehicle (not illustrated) in addition to one or more cameras positioned such that the exterior of the vehicle can be viewed. The one or more cameras can be used by the primary service controller 135 to view people who want to enter the vehicle 110. Thereafter, using the application on the remote device 130/200/300, primary service controller 135 can approve or disapprove specific people from entering the vehicle. For those who are not authorized to enter the vehicle, the vehicle can be configured to remain in a locked state to prevent unauthorized people from entering the vehicle. In a case where an unauthorized person somehow managed to enter the vehicle (for example, the unauthorized person entered the vehicle while the vehicle was unlocked to allow an authorized person to enter), the presence of the unauthorized person can be noted by the one or more cameras located in the vehicle. In such a situation, the vehicle can be prevented from moving in one of a variety of different manners. For example, vehicle 110 can be prevented from entering a drive mode, or the engine can be prevented from starting while the unauthorized person is present. This can be useful both from a safety perspective (e.g., a criminal cannot just take the vehicle and/or harm passengers 120), but it is also useful from a parenting perspective (e.g., passengers 120 cannot give a ride to non-approved friends).

Different situations would call for different levels of control for primary service controller 135. For example, the passenger 120 may be a person who is suffering from an impairment to her cognitive abilities. In such a situation, it may be desirable to completely lock down the vehicle. Thus, slider 320 or 220 would be set at or near the “close care” side in that the passenger 120 can have little to no control of the vehicle, with only primary service controller 135 having those abilities.

The other end of the sliding scale can be “freedom.” In such a situation, the passenger 120 can have full control of the vehicle and primary service controller 135 has no remote control capabilities. An exemplary situation can occur when a third-party is paying for a ride-sharing service for a customer. For example, a corporation is paying for a client, or a spouse is paying for a spouse, or one family member is paying for another family member.

Intermediate portions of the sliding scale also can be used. As described above, the passengers 120 may include both a toddler and the toddler's babysitter. In such a case, the primary service controller 135 can adjust the sliding scale 320 or 220 closer to the “freedom” side. The primary service controller 135 might not want to give up complete control of the vehicle 110 (to restrict the destinations that the babysitter can input), but with the babysitter supervising the toddler, allowances can be made to allow the babysitter to make unscheduled stops (e.g., for a bathroom break) or to control other aspects of vehicle 110 (e.g., adjusting the climate control, opening a window, or playing a video).

In some embodiments, the application can have viewing capabilities such that a view of the interior of the vehicle 110 can be displayed to the primary service controller 135. The vehicle 110 can have one or more cameras, video sensors, microphones, three-dimensional sensors, and the like (not illustrated). Thus, primary service controller 135 is able to view the interior (and exterior) of the vehicle 110 as well as listen to the interior of the vehicle. Such a capability can be especially useful as the slider gets closer to the “close care” end of the sliding scale. In such a situation, primary service controller 135 might be worried about the condition of the passenger 120 and want the ability to perform a visual check. At the other end of the slider, “freedom” might give no video capabilities to primary service controller 135, to give the passenger privacy.

A flowchart illustrating method 400 is presented in FIG. 4. Method 400 is merely exemplary and is not limited to the embodiments presented herein. Method 400 can be employed in many different embodiments or examples not specifically depicted or described herein. In some embodiments, the procedures, processes, and/or activities of method 400 can be performed in the order presented. In other embodiments, one or more of the procedures, processes, and/or activities of method 400 can be combined or skipped. In one or more embodiments, method 400 is performed by a processor as it is executing instructions.

Method 400 illustrates an exemplary interaction between a primary service provider 135 and one or more embodiments in ordering an automotive vehicle service for a passenger 120 from a ride sharing service, where the primary service provider 135 is not located in vehicle 110. A system receives an order of a vehicle from a primary service provider 135 (block 402). The order can note that the order is from a primary service provider 135 who will be remote from the vehicle 110. The order can be made in one of a variety of different manners. For example, an application that is accessible on a remote device 130 can be used, or a web-based interface can be used to place the order. The order can make a number of different requests. For example, the origin or place where passenger(s) 120 are picked is noted in the request. The destination information is also noted in the request.

Making such a request can occur in one of a variety of different manners, both those already existing and those developed in the future. The application can accept an address as a text input for the origin or destination. In some embodiments, a map can be used by primary service provider 135 to select the origin or destination. In some embodiments, the primary service provider 135 can establish an account with the ride sharing service. In such a case, primary service provider 135 can input one or more preset destinations, such as his home, office, doctor's office, medical facility, or any other frequently used location as “favorite” locations. In such a manner, primary service provider 135 is able to save multiple locations for later use.

A vehicle 110 can be dispatched to the origin location (block 404). This can occur in one of a variety of different manners. In some embodiments, a back office server (such as back office server 140) can track a real-time location of multiple vehicle under control of the back office server.

The vehicle 110 that is dispatched to the origin can be chosen in a variety of different manners. One method of dispatching a vehicle 110 is to determine which vehicle is closest to the origin (either by distance or by estimated time of arrival). Other methods can include taking into account various needs input by the primary service provider 135. For example, if there are multiple passengers 120, the dispatched vehicle 110 should have enough room to transport all of them. If the passenger 120 has medical issues, the dispatched vehicle could have certain medical sensors or the capability to interface with certain wearable sensors. The vehicle should have enough fuel to complete the trip.

The dispatch results in the vehicle being driven to the origin location. In embodiments using vehicles with high levels of autonomy, this can occur without any user input.

The passenger(s) 120 board the vehicle (block 406). In some embodiments, there can be user identification features that can be used to ensure that the person boarding the vehicle is the intended passenger. This can include the use of biometric sensors (e.g., fingerprint sensors, retina scanners, and the like), facial recognition, a password that is said or input at the vehicle, and the like. The primary service provider might have an account with the ride sharing service. In such a case, information about the users may already be available to the ride sharing service. If such information is not available, the primary service provider 135 can supply such information at block 402.

The vehicle transports the passenger(s) 120 to the destination (block 408). During the trip, the passenger 120 can have one of a variety of different levels of control over the vehicle, as described with respect to FIGS. 2 and 3. The primary service provider 135 can set the level of control using the application (block 410). This setting can be performed at any time during the trip and even changed during the trip.

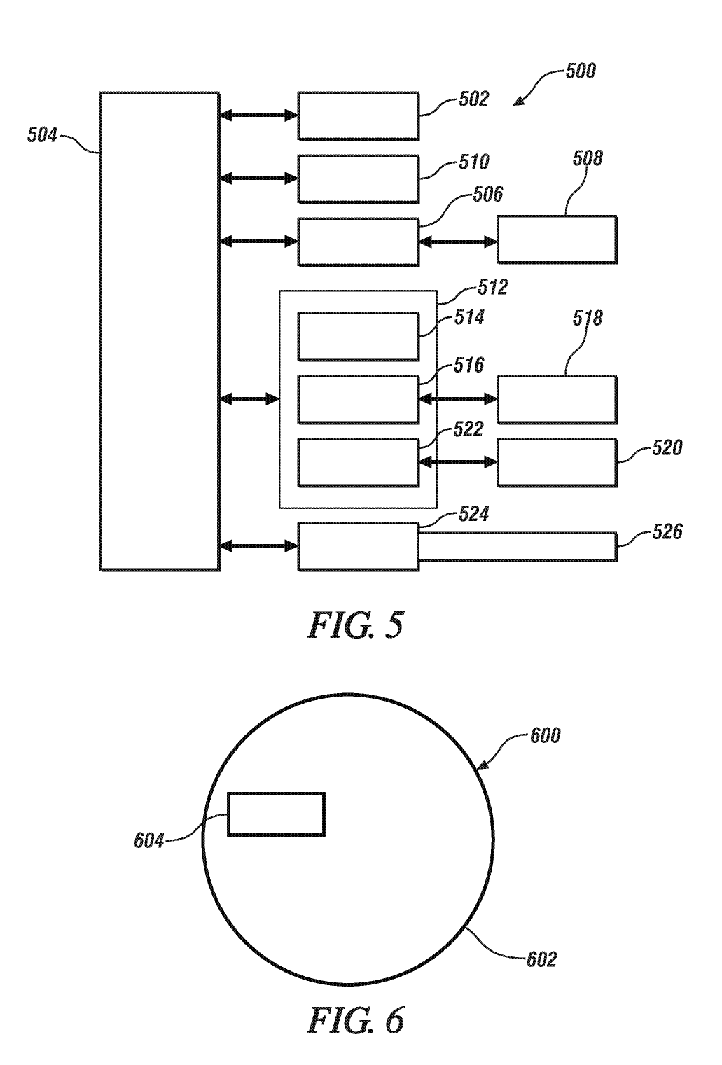

FIG. 5 depicts a high-level block diagram of a computer system 500, which can be used to implement one or more embodiments. More specifically, computer system 500 can be used to implement hardware components of systems capable of performing methods described herein. Although one exemplary computer system 500 is shown, computer system 500 includes a communication path 526, which connects computer system 500 to additional systems (not depicted) and can include one or more wide area networks (WANs) and/or local area networks (LANs) such as the Internet, intranet(s), and/or wireless communication network(s). Computer system 500 and additional system are in communication via communication path 526, e.g., to communicate data between them.

Computer system 500 includes one or more processors, such as processor 502. Processor 502 is connected to a communication infrastructure 504 (e.g., a communications bus, cross-over bar, or network). Computer system 500 can include a display interface 506 that forwards graphics, textual content, and other data from communication infrastructure 504 (or from a frame buffer not shown) for display on a display unit 508. Computer system 500 also includes a main memory 510, preferably random access memory (RAM), and can also include a secondary memory 512. Secondary memory 512 can include, for example, a hard disk drive 514 and/or a removable storage drive 516, representing, for example, a floppy disk drive, a magnetic tape drive, or an optical disc drive. Hard disk drive 514 can be in the form of a solid state drive (SSD), a traditional magnetic disk drive, or a hybrid of the two. There also can be more than one hard disk drive 514 contained within secondary memory 512. Removable storage drive 516 reads from and/or writes to a removable storage unit 518 in a manner well known to those having ordinary skill in the art. Removable storage unit 518 represents, for example, a floppy disk, a compact disc, a magnetic tape, or an optical disc, etc. which is read by and written to by removable storage drive 516. As will be appreciated, removable storage unit 518 includes a computer-readable medium having stored therein computer software and/or data.

In alternative embodiments, secondary memory 512 can include other similar means for allowing computer programs or other instructions to be loaded into the computer system. Such means can include, for example, a removable storage unit 520 and an interface 522. Examples of such means can include a program package and package interface (such as that found in video game devices), a removable memory chip (such as an EPROM, secure digital card (SD card), compact flash card (CF card), universal serial bus (USB) memory, or PROM) and associated socket, and other removable storage units 520 and interfaces 522 which allow software and data to be transferred from the removable storage unit 520 to computer system 500.

Computer system 500 can also include a communications interface 524. Communications interface 524 allows software and data to be transferred between the computer system and external devices. Examples of communications interface 524 can include a modem, a network interface (such as an Ethernet card), a communications port, or a PC card slot and card, a universal serial bus port (USB), and the like. Software and data transferred via communications interface 524 are in the form of signals that can be, for example, electronic, electromagnetic, optical, or other signals capable of being received by communications interface 524. These signals are provided to communications interface 524 via communication path (i.e., channel) 526. Communication path 526 carries signals and can be implemented using wire or cable, fiber optics, a phone line, a cellular phone link, an RF link, and/or other communications channels.

In the present description, the terms “computer program medium,” “computer usable medium,” and “computer-readable medium” are used to refer to media such as main memory 510 and secondary memory 512, removable storage drive 516, and a hard disk installed in hard disk drive 514. Computer programs (also called computer control logic) are stored in main memory 510 and/or secondary memory 512. Computer programs also can be received via communications interface 524. Such computer programs, when run, enable the computer system to perform the features discussed herein. In particular, the computer programs, when run, enable processor 502 to perform the features of the computer system. Accordingly, such computer programs represent controllers of the computer system. Thus it can be seen from the forgoing detailed description that one or more embodiments provide technical benefits and advantages.

Referring now to FIG. 6, a computer program product 600 in accordance with an embodiment that includes a computer-readable storage medium 602 and program instructions 604 is generally shown.

Embodiments can be a system, a method, and/or a computer program product. The computer program product can include a computer-readable storage medium (or media) having computer-readable program instructions thereon for causing a processor to carry out aspects of one or more embodiments.

The computer-readable storage medium can be a tangible device that can retain and store instructions for use by an instruction execution device. The computer-readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network can comprise copper transmission cables, optical transmission fibers, wireless transmission, routers, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out embodiments can include assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Smalltalk, C++ or the like, and conventional procedural programming languages, such as the “C” programming language or similar programming languages. The computer-readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer-readable program instructions by utilizing state information of the computer-readable program instructions to personalize the electronic circuitry, in order to perform embodiments.

While the foregoing has been described with reference to exemplary embodiments, it will be understood by those skilled in the art that various changes may be made and equivalents may be substituted for elements thereof without departing from the scope. In addition, many modifications may be made to adapt a particular situation or material to the teachings without departing from the essential scope thereof. Therefore, it is intended that the disclosure not be limited to the particular embodiments disclosed, but that all embodiments fall within the scope of the application.

1. A method for controlling an autonomous vehicle comprising:
using a software application to order the autonomous vehicle to make a trip;
using the software application to determine an amount of control over the autonomous vehicle held by one or more passengers of the trip, wherein the software is being used remotely from the autonomous vehicle, wherein determining an amount of control over the autonomous vehicle comprises presenting a graphical user interface to a non-passenger who is remote from the vehicle, the graphical user interface comprising a slider having a moveable portion that is moveable relative to the slider, the movable portion moveable by the non-passenger to input a level of control to provide to the one or more passengers of the vehicle.

2. The method of claim 1 wherein:
determining an amount of control over the autonomous vehicle includes providing remote approval for the boarding of passengers on the vehicle.

3. The method of claim 2 wherein providing remote approval for the boarding of passengers on the vehicle comprises:
viewing a video image from a proximity of the vehicle; and
providing an approval of the boarding of passengers using the software application.

4. The method of claim 2 wherein:
providing remote approval for the boarding of passengers on the vehicle includes allowing the one or more passengers to provide approval for the boarding of passengers.

5. The method of claim 1 wherein:
determining an amount of control over the autonomous vehicle includes controlling an availability of services provided by the vehicle.

6. The method of claim 5 wherein the services include provision of food or beverages to the one or more passengers.

7. The method of claim 1 wherein:
determining an amount of control over the autonomous vehicle includes controlling an availability to one or more passengers of the vehicle of one or more of the following: seat controls, window controls, audio/visual controls, heating controls, and air conditioning controls.

8. The method of claim 1 wherein:
determining an amount of control over the autonomous vehicle includes controlling an availability of destination control provided to one or more passengers of the vehicle.

9. (canceled)

10. A method for controlling an autonomous vehicle comprising:
receiving an order for the autonomous vehicle to make a trip;
dispatching the autonomous vehicle to a requested location;
receiving instructions regarding an amount of control over the autonomous vehicle held by one or more passengers of the trip, wherein the instructions are received from a non-passenger who is located remotely from the autonomous vehicle, the non-passenger being presented with a graphical user interface comprising a slider having a moveable portion that is moveable relative to the slider, the movable portion moveable by the non-passenger to input a level of control to provide to the one or more passengers of the vehicle, the slider comprising a plurality of preset levels of control that are numbered or named.

11. The method of claim 10 wherein:
the instructions regarding the amount of control over the autonomous vehicle include remote approval of the boarding of passengers on the vehicle.

12. The method of claim 11 wherein the remote approval for the boarding of passengers on the vehicle comprises:
providing a video image from a proximity of the vehicle to the remote device; and
receiving an approval of the boarding of passengers from the remote device.

13. The method of claim 11 wherein:
receiving approval for the boarding of passengers on the vehicle includes receiving instructions to allow the one or more passengers to provide approval for the boarding of passengers.

14. The method of claim 10 wherein:
receiving instructions regarding the amount of control over the autonomous vehicle includes controlling an availability of services provided by the vehicle.

15. The method of claim 14 wherein the services include provision of food or beverages to the one or more passengers.

16. The method of claim 10 wherein:
receiving instructions regarding the amount of control over the autonomous vehicle includes controlling an availability to one or more passengers of the vehicle of one or more of the following: seat controls, window controls, audio/visual controls, heating controls, and air conditioning controls.

17. The method of claim 10 wherein:
receiving instructions regarding the amount of control over the autonomous vehicle includes controlling an availability of destination control provided to one or more passengers of the vehicle.

18. (canceled)

19. A system comprising:
an autonomous vehicle;
a server in communication with the autonomous vehicle;
a remote device in communication with the server; wherein the remote device is configured to:
use a software application to order the autonomous vehicle to make a trip;
use the software application to determine an amount of control over the autonomous vehicle held by one or more passengers of the trip, wherein the software is being used remotely from the autonomous vehicle, wherein determining an amount of control over the autonomous vehicle comprises presenting a graphical user interface to a non-passenger who is remote from and not within the vehicle, the graphical user interface comprising a first slider having a first moveable portion and a second slider having a second moveable portion, the first moveable portion being moveable, relative to the first slider, by the non-passenger to input a first level of control to provide to the one or more passengers of the vehicle, and the second moveable portion being moveable, relative to the second slider, by the non-passenger to input a level of control to indicate who is allowed in the vehicle.

20. The system of claim 19 wherein determining an amount of control over the autonomous vehicle includes controlling an availability of destination control provided to one or more passengers of the vehicle.
